(19) United States
(12) Patent Application Publication
(10) Pub. No.: US 2026/0222532 A1
(43) Pub. Date: Jul. 30, 2026

(54) METHOD FOR SCALING SIZE AND DEPTH IN VIDEOCONFERENCING

(71) Applicant: Dimenco Holding B.V., Veldhoven (NL)

(72) Inventors: Jurjen Caarls, Eindhoven (NL); Patrick Godefridus Jacobus Maria Peeters, Veldhoven (NL); Pieter Wilhelmus Theodorus de Jong, Hertogenbosch (NL); Youri De Rooij, Veldhoven (NL)

(21) Appl. No.: 19/139,239

(22) PCT Filed: Dec. 15, 2023
(86) PCT No.: PCT/NL2023/050661

§ 371 Date: Jun. 13, 2025

(30) Foreign Application Priority Data
Dec. 15, 2023 (NL) 2033733

(51) Int. Cl. H04N 13/398; H04L 65/403; H04L 65/613; H04N 13/128; H04N 13/139; H04N 13/189; H04N 13/239; H04N 13/305; H04N 13/31; H04N 13/366; H04N 23/90

(52) U.S. Cl. CPC H04N 13/398; H04L 65/403; H04L 65/613; H04N 13/128; H04N 13/139; H04N 13/189; H04N 13/239; H04N 13/366; H04N 23/90; H04N 13/305; H04N 13/31

(57) ABSTRACT

The invention relates to a method for driving a screen of a first autostereoscopic display device to display a stereoscopic image of a first person to a second person, wherein the second person is a viewer residing in a field of view of the screen of the first autostereoscopic display device. The method comprises scaling of the stereoscopic image in terms of size and depth. In a preferred embodiment, the scaled size and the scaled depth are in agreement with those that one would experience in the real world. The method of the invention is advantageously used for videoconferencing, so that a stereoscopic image of the first person can be displayed to a second person, and a stereoscopic image of the second person can be displayed to the first person.

### FIELD OF THE INVENTION

The invention relates to a method for driving a screen of an autostereoscopic display device to display a stereoscopic image of a first person to a second person.

### BACKGROUND

One of the areas wherein autostereoscopic displays have found a useful and entertaining application is videoconferencing, which is commonly understood as holding a technology-enabled type of meeting where participants in different locations are able to communicate with each other in sound and vision. A great advantage of videoconferencing is obviously that people do not have to travel to become part of a situation where they can talk to and see each other.

The role played herein by autostereoscopic displays is to make an encounter between people more realistic than is the case with monoscopic displays. Autostereoscopic displays allow a viewer in a videoconference to perceive a remote participant as a three-dimensional image, without the need for a dedicated eyewear device such as glasses. This allows a viewer to experience that he is physically present in a real environment, and that he is at the same time also part of an environment displayed by the autostereoscopic display-a virtual environment that is observable in three dimensions through a virtual window formed by the screen of the autostereoscopic display. To the viewer, the remote participant may appear in front of the virtual window or behind the virtual window; or partly in front and partly behind it.

Current videoconferencing systems however still have some shortcomings in displaying a remote participant in a realistic manner. Typically, they fail in presenting a remote participant at a realistic size and at a comfortable distance to the viewer. In particular, the size of a remote participant does not match with the distance at which he is perceived, e.g. with the distance at which he would be observed from the same distance through a real window.

A further discrepancy with reality is that when the viewer moves towards or away from the autostereoscopic display, the size of the remote participant does not change accordingly.

### SUMMARY OF THE INVENTION

It is therefore an object of the present invention to provide a method to improve the viewing experience of a viewer of an autostereoscopic display device when he views a particular person on the autostereoscopic display device, in particular when he views a remote participant when he is in a videoconference with such remote participant. It is in particular an object to provide a method that allows the adjustment of the way of displaying a person in accordance with the viewer's personal preferences.

It is more in particular an object of the present invention to provide a method that allows the display of a person, in particular a remote videoconferencing participant, at a realistic size and at a desired distance to the viewer.

It is also an object that the perceived size and the perceived distance may be adjusted to a particular extent that is not necessarily the most realistic, but merely the most convenient and/or the most desirable to the viewer.

It has now been found that one or more of these objects can be reached by a proper scaling of three-dimensional content that is to be displayed by the autostereoscopic display.

Accordingly, the present invention relates to a method for driving a screen of a first autostereoscopic display device to display a stereoscopic image of a first person to a second person, wherein the second person is a viewer residing in a field of view of the screen of the first autostereoscopic display device, the method comprising
providing a stereoscopic recording of the first person by means of a stereo camera;
displaying to the second person the stereoscopic recording of the first person as a stereoscopic image composed of a left eye image and a right eye image, wherein the second person perceives the first person
   with an apparent displayed size, which is the angular size of the first person when the first person is viewed on the screen by the second person; and
   at a displayed depth, which is the depth at which the second person perceives the first person;
      wherein the method comprises
adjusting the apparent displayed size to a desired apparent displayed size by scaling the stereoscopic image of the first person;
adjusting the displayed depth to a desired displayed depth by changing a disparity between the left eye image and the right eye image of the first person.

### BRIEF DESCRIPTION OF THE DRAWINGS

FIG. 1 schematically displays a conventional setting for applying the present invention, from which relations between recording and displaying can be explained.

FIG. 2 schematically displays possible outcomes when the method of the present invention is applied.

FIG. 3 schematically displays a videoconferencing setting wherein a method according to the present invention is applied.

### DETAILED DESCRIPTION OF THE INVENTION

The figures do not limit the present invention to the specific embodiments disclosed therein and described in the present description. Elements in the figures are illustrated for simplicity and clarity and have not necessarily been drawn to scale, emphasis instead being placed upon clearly illustrating the principles of the invention.

In the context of the invention, the term ‘stereoscopic image’ is meant to indicate an image that is composed of a left eye image that is to be presented to a left eye of the viewer and a right eye image that is to be presented to a right eye of the viewer. In this way, the image may be perceived by a viewer as being three-dimensional (although it is strictly spoken not a true three-dimensional image). A left eye image and right eye image may also be displayed at an area close to the respective eye, as long as it does not hit the other eye. In practice, there is however always a small (or very small) portion of light that ‘leaks’ to the other eye (crosstalk), although viewers may not always be aware of this and still rate their three-dimensional viewing experience as satisfying.

In the context of the invention, a stereoscopic recording is meant to contain information that represents a three-dimensional visible image in that it can be used to display such stereoscopic image, when inputted to an autostereoscopic display device in a format processable by this device. A stereoscopic recording is a record or live-stream of a real scene, person or object, captured by a stereo camera and comprising information on the three-dimensionality of the scene, person or object. It may be stored in a memory part associated with the device so that it can be displayed on request; or it may be displayed as live video that is captured by a stereo camera associated with the autostereoscopic display device.

When a stereoscopic recording in a method of the invention is a recording of a person, then the recording may initially also comprise surroundings in the person's environment. When displaying such recording as an image, the person, or a body part of the person such as a head, may be segmented from any surroundings, so that an image of the person (or body part) is free of any surroundings. This allows the introduction of a background to the image.

In the context of the invention, by the term ‘stereo camera’ is meant a camera that is capable of providing a stereoscopic recording of a real scene, person or object. From such stereoscopic recording, a stereoscopic image can be made. For the purpose of the invention, a stereo camera is meant to include a stereoscopic camera and a plenoptic camera. Further, the term stereo camera may comprise a plurality of (stereo) cameras that together from and provide the capabilities of a stereo camera as set out above.

In the context of the invention, by the term ‘viewer’ is meant a person consuming the content that is presented to him according to the method of the invention. Besides viewing the stereoscopic image, the viewer may also experience other sensory stimulus such as sound or haptic stimulus. For convenience, however, such person is consequently referred to as ‘viewer’, although it is understood that he may at the same time also be e.g. a ‘listener’.

In the method of the invention, the ‘second person’ is always characterized by being a viewer. The ‘first person’ is then recorded by a stereo camera and capable of being viewed by the second viewer. In the event that the second person is also recorded by a stereo camera, causing him to be capable of being viewed by the first person, then both the first person and the second person are viewers.

Throughout the text, references to the viewer will be made by male words like ‘he’, ‘him’ or ‘his’. This is only for the purpose of clarity and conciseness, and it is understood that female words like ‘she’, and ‘her’ equally apply. For the same reason, the terms ‘person’ and ‘participant’ will also be referred to by male words.

A method of the invention makes use of one or more autostereoscopic display devices. Such device is typically a device that is largely stationary in the real world during its use, such as a desktop device or a wall-mounted device. For example, the autostereoscopic display device is a television, a (desktop) computer with a monitor, a laptop, or a cinema display system. It may however also be a portable device such as a mobile phone, a display in a car, a tablet or a game console, allowing a viewer to (freely) move in the real world together with the autostereoscopic display device.

Autostereoscopic display devices are known in the art, e.g. from WO2013120785A2. The main components of an autostereoscopic display device used in a method of the invention typically are an eye tracking system, a screen, a processing unit, and optional audio means.

The eye tracking system comprises means for tracking the position of a viewer's eyes relative to the autostereoscopic display device and is in electrical communication with the processing unit. The eye position is required for correctly weaving the left eye image and the right eye image to the array of pixels, so that each image hits the intended eye, even when the viewer moves relative to the screen of the autostereoscopic display device.

The viewing distance of a viewer's eyes to the screen is typically also obtained by using the eye tracking system. Alternatively, it is possible that separate means are present for determining this viewing distance.

The recording distance of a viewer relative to the stereo camera may be obtained by using the eye tracking system or a different system that is associated with or integrated in the stereo camera.

The screen comprises means for displaying a stereoscopic image to a viewer whose eyes are tracked by the eye tracking system. Such means comprise an array of pixels for producing a display output and a parallax barrier or a lenticular lens that is provided over the array to direct a left eye image to the viewer's left eye and a right eye image to the viewer's right eye.

The processing unit is inputted with the stereoscopic recording and configured to drive the screen, taking into account the data obtained by the eye tracking system. An important component of the processing unit is therefore the so-called ‘weaver’, which weaves a left eye image and a right eye image to the array of pixels, thereby determining which pixels are to produce pixel output in correspondence with the respective image. In this way, a stereoscopic image can be displayed to a viewer at a particular position.

The processing unit is typically also configured to perform the stereoscopic image adjustment in accordance with the method of the invention, viz. adjusting the apparent displayed size and the adjusting the displayed depth of the stereoscopic image.

The optional audio means comprise means for playing sound to the viewer. For example, audio means comprises one or more devices selected from the group of stereo loudspeakers, loudspeaker arrays, head phones and ear buds. An autostereoscopic display device used in a method of the invention typically comprises a receiver for receiving a stereoscopic recording of a person in the real world. This also includes receiving a live video stream of a person in the real world. An audio recording or audio stream may also be received by such receiver. Transfer of video and/or audio recordings may occur via e.g. a wireless connection or a telecommunications line.

An autostereoscopic display device used in a method of the invention may comprise a memory to store a stereoscopic recording of a scene, person or object in the real world.

An autostereoscopic display device used in a method of the invention may comprise a stereo camera for recording the viewer and/or a means for determining the recording distance of the viewer to the stereo camera. The latter device may be integrated in the stereo camera. Optionally, an audio recording device for recording sounds of the viewer and/or around the viewer is also part of an autostereoscopic display device. Recordings made with such stereo camera, and/or with such audio recording device may be transferred to a different environment to be presented to another viewer. Determined recording distances may also be transferred to such different environment.

When a viewer of an autostereoscopic display devices sees a stereoscopic recording of another person as a stereoscopic image on a screen of the autostereoscopic display device (without application of the method of the invention), then size and depth of the other person as perceived by the viewer are usually unrealistic when taking into account the viewing distance and the perceived depth. Alternatively, the viewer may prefer to view the remote person at a specific size and depth that are different from the ‘real’ size and depth, for example because such preferred size and depth are more appealing to the viewer. The present invention provides a solution to this by allowing a viewer to adjust the scale and depth of the displayed stereoscopic image.

The solution provided by the present invention to arrive at a certain size and depth takes into account a so-called ‘apparent size’ of a to-be-recorded person in the real world and translates this to the displaying of an image of the recorded person on a screen.

The term ‘apparent size’ of a person is meant to indicate the angular distance from one side (or one particular point) of the person to an opposite side (or a second particular point) of the person. This can be thought of as the angular displacement through which an eye or camera must rotate to look from one side (or point) to an opposite side (or point). Since a person is of an irregular shape, having opposite sides that may be difficult to define, an apparent size of a person is, according to the invention, in practice often obtained by defining two facial characteristics of a person and determining their angular displacement, such as eyes or ears. It is then important that other determinations of angular size of the person, for the purpose of carrying out the method of the invention, are performed on the same features of the person.

Within the context of the invention, there are two types of apparent size; 1) apparent displayed size; and 2) apparent real world size.

An apparent displayed size of a person in an image is the person's angular size as perceived by a viewer who views the image as a displayed image on a screen. Herein, the viewed person may be perceived in the plane of the screen or at a particular distance to the screen (i.e. at a particular depth from the perspective of the viewer).

An apparent real world size of a person is the person's angular size as perceived by a viewer who views the person in the real world from a particular distance. Within the context of the invention, the viewed person is a person of whom an image is recorded by a stereo camera at a recording distance (which is the distance between the person and the stereo camera that makes a recording of him). The viewed person's apparent real world size is then his angular size as perceived by a viewer when the viewer would view him in the real world from the recording distance (i.e. when the viewer's viewpoint is the viewpoint of the stereo camera).

For the purpose of the invention, a ‘desired apparent displayed size’ is defined, which is an apparent displayed size that is arrived at when the method of the invention has been performed. The same applies, mutatis mutandis, to the term ‘desired displayed depth’. Both terms refer to an adjustment of a parameter to a value that is preferred by e.g. someone involved in a method of the invention and/or in an environment where a displaying or a recording is performed according to a method of the invention, such as the second person.

In the method of the invention, the person that is stereoscopically recorded and whose image is displayed on the screen of an autostereoscopic display device, is referred to as the ‘first person’. The person who views the image of the first person is referred to as ‘second person’. In an optional embodiment, the inverse may in addition apply, when the second person is also stereoscopically recorded and when the first person views the image of the second person. In such embodiment, videoconferencing is possible.

A stereoscopic image of a person does not necessarily contain the person as a whole. The image may also comprise a part of the person, typically the head. Accordingly, in a method of the invention, the stereoscopic recording of the first person may be represented by a stereoscopic recording of the head of the first person, so that the stereoscopic image of the first person is represented by a stereoscopic image of the head of the first person.

In a method of the invention, the depth is scaled by changing the disparity between the left eye image and the right eye image of a person. It is recognized that such depth scaling is in fact an approximation of a true depth scaling, since the recording distance is not specifically controlled in order to effect depth scaling. For many applications of the present invention, such as video conferencing, such approximation is acceptable to a viewer, especially when the change in disparity is not extreme.

A preferred way to arrive at a certain desired apparent displayed size of the first person comprises deriving it from the desired displayed depth, by performing the steps of
a) providing the desired displayed depth at which the second person perceives the first person;
b) determining a viewing distance of the second person's eyes to the screen;
c) determining a recording distance of the first person to the stereo camera;
d) determining an apparent real world size of the first person, which is the angular size when the first person is viewed in the real world from the recording distance obtained under c);
e) calculating the desired apparent displayed size of the first person, which is the angular size when the first person is viewed in the real world from the desired displayed depth provided under a), by using
   the desired displayed depth provided under a);
   the viewing distance obtained under b);
   the apparent real world size obtained under d);
f) scaling the stereoscopic image to adjust the apparent displayed size to the desired apparent displayed size;
g) fitting the stereoscopic image that is scaled in step f) to the screen by cropping the image when the image is larger than the screen.

Herein, it is described to set the desired apparent displayed size at a value that is in line with the depth that is perceived by the second person when the first person is displayed at the desired displayed depth. To this end, the stereoscopic image of the first person is scaled to a certain extent so as to reach the desired apparent displayed size. The first person is thus perceived at a size which the second person may expect given the depth at which he perceives the first person.

If desired, the stereoscopic image of the first person may also be scaled to a different size. This may be preferred when realistic dimensions are less important and/or when it is undesired that an image of a person covers an exceptionally large or an exceptionally small part of the screen. For example, the screen may be too small for a proper displaying of the stereoscopic image (or, equivalently, the first person may be too close to the stereo camera, leading to an oversized image at the screen of the second person).

For example, an additional scaling may occur according to a first percentage that is in the range of 50-150%, in particular in the range of 80-120%, more in particular in the range of 95-105% and even more in particular in the range of 99-101%. In this way, the second person is allowed to adjust the desired apparent displayed size to an even more desired apparent displayed size.

In the method of the invention, wherein the first person is viewed by the second person, the scaling percentage desired by the second person is referred to as the first percentage. In the reversed case wherein, in addition, an image of the second person is viewed by the first person, the percentage is referred to as the second percentage, as will be further explained below.

A stereoscopic image of a person that is to be scaled according to the invention is typically present at a distance from the stereo camera that is within a range where stereoscopy is possible. Typically this is at a distance of less than 25 m, preferably at a distance of less than 10 m, more preferably at a distance of less than 7 m and even more preferably at a distance of less than 5 m. For example, it is less than 4 m, less than 3 m or less than 2 m. It is for example in the range of 0.50-2.0 m, in particular in the range of 0.80-1.6 m.

An image of the first person may comprise the real background behind the first person at the moment the stereoscopic recording of the first person is made, i.e. the original background that is part of the reality wherein the first person is present. Usually, however, the first person is segmented from the original background, so that the displayed image of the first person does not comprise the original background. Such segmentation of parts of an image can be performed according to methods known in the art.

When a background is lacking due to such segmentation of the first person (or e.g. the head of the first person), then another background is usually introduced behind the stereoscopic image of the first person. Such background can be scaled to a first desired extent, which usually occurs independently of the scaling of the stereoscopic (foreground) image of the first person. Without segmentation of the first person from the background, the scaling of the stereoscopic image of the first person will result in scaling of the background to the same extent. This may give a weird appearance of the background to the viewer of the image.

Accordingly, a method of the invention may further comprise
providing a recording of a background, obtained by a camera or a stereo camera;
simultaneously displaying on the screen to the second person
   the recording of the background as a background image; and
   the stereoscopic recording of the first person as an stereoscopic foreground image;
optionally scaling the background image to a first desired extent;
fitting the background image to the screen by cropping the image when the image is larger than the screen.

Usually, a method of the invention is performed a plurality of times in a sequence. In this way, a new position of the first and/or second person relative to an autostereoscopic display and a stereo camera, respectively, can be accounted for. For example, the method is repeated at least 10 times, at least 100 times, at least 1,000 times, at least 10,000 times, at least 100,000 times or at least 1,000,000 times. Any repetition of the method of the invention, for example with one of the above numbers, may reflect a particular viewing session of the viewer. For a realistic viewing experience, the method is usually performed at a frequency that is at least 10 times per second. Preferably, the frequency is at least 20 times per second, more preferably at least 30 times per second, and even more preferably at least 50 times per second. For example, it is in the range of 50 -250 times per second, in the range of 55-150 times per second or in the range of 60-120 times per second. It may in particular be 60 Hz, 120 Hz, 144 Hz or 240 Hz. Preferably, it is at the same frequency as a refresh rate of the screen itself.

When a method of the invention is performed a plurality of times, then it may be advantageous to allow the second person to perceive the first person at (substantially) the same depth relative to the screen, each time the method is performed.

For example, the second person may prefer to constantly perceive the first person just behind the screen (or with the eyes in the plane of the screen) wherein the first person has a more or less constant coverage of screen area as observed by the second person, even when the first person has a varying position relative to the stereo camera so that there is a varying recording distance. This gives the first person a more steady image to look at, wherein the displayed image does not constantly jump between different sizes when the first person moves away from or towards the stereo camera.

The perceived depth may however also follow the varying recording distance to a minor extent, which will already increase viewing comfort as experienced by the second viewer. For example, the perceived depth exhibits a variation between a lower value and a higher value, wherein the higher value is up to 2 times the lower value. It is for example up to 1.6 times the lower value, up to 1.5 times the lower value, up to 1.4 times the lower value, up to 1.3 times the lower value, up to 1.2 times the lower value, up to 1.1 times the lower value, up to 1.07 times the lower value, up to 1.05 times the lower value, up to 1.03 times the lower value, up to 1.02 times the lower value, or up to 1.01 times the lower value.

Especially when the recording distance is reduced by a large percentage (e.g. when the first person comes rather close to the stereo camera that is recording him), screen coverage as observed by the second person would normally increase enormously. Such increase exceeds the enlargements that are inherently perceived by a viewer when observing objects at close range, because the recording distance becomes much smaller than the displayed depth.

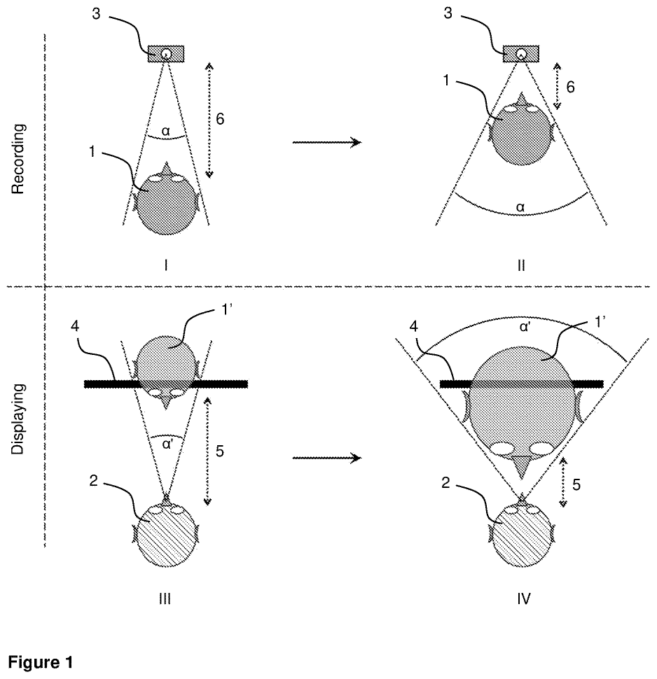

The effect of a first person (1) who moves closer to a stereo camera (3) on displaying him on an autostereoscopic screen (4) to the second person (2) is illustrated in FIG. 1. The upper side of the Figure displays a top view of two recording situations, left (I) and right (II), where the first person (1) is recorded by a stereo camera (3). In the left recording situation (I), the first person (1) is further away from the stereo camera (3) than in the right recording situation (II). The bottom side of the Figure displays two top view displaying situations, left (III) and right (IV), where the first person (1) is displayed to the second person (2) on a screen (4) as the displayed first person (1′). The displayed first person (1′) in the left (III) and right (IV) displaying situations corresponds to the first person (1) as recorded in the left (I) and right (II) recording situations, respectively. The two schematical displaying situations (III and IV) on the bottom of FIG. 1 reflect that the first person (1′) is displayed on the screen (4) as a stereoscopic image. This is because the displayed first person (1′) has been drawn in the situations (III and IV) with a dimension that extends perpendicular to the screen (4), reflecting that the second person (2) may perceive that a part of the displayed first person (1′) is nearer (e.g. in front of the screen) and that another part is further away (e.g. behind the screen). Further, the two schematical displaying situations (III and IV) in the bottom of FIG. 1 illustrate that the first person (1′) has a displayed depth (5), which is the depth at which the second person (2) perceives the first person (1′).

In the left recording situation (I), the first person (1) is at an initial recording distance (6) from the camera (3) where it has an initial apparent real world size (a). In the left displaying situation (III), the second person (2) observes the displayed first person (1′) at an initial displayed depth (5) and with an initial apparent displayed size (a'), both not differing much from the initial recording distance (6) and the initial apparent real world size (α), respectively, of the left recording situation (I). Movement of the first person (1) towards the camera (3) is illustrated by the transformation from the left recording situation (I) to the right recording situation (II) (indicated by the arrow). In the latter situation, the first person (1) is at a final recording distance (6) from the camera (3) where it has a final apparent real world size (α). The effect of this movement of the first person is illustrated in the right displaying situation (IV), where the second person (2) observes the displayed first person (1′) at a final displayed depth (5) and with a final apparent displayed size (α′). The displayed depth has enormously decreased, since the second person (2) now perceives the first person (1′) right in front of him. Moreover, the apparent displayed size has also undergone an enormous increase, with the autostereoscopic image of the first person (1′) being much larger than the second person (2). So, in the right displaying situation (IV), the second person (2) perceives the first person (1′) as very large and at a very short range.

A method of the present invention is however able to compensate for such effects, allowing the display of the first person (1′) at a reduced final apparent displayed size (α′) and at an increased final displayed depth (5). In other words, the invention allows the display of a real person (or scene or object) at a particular (more or less) constant perceived depth and at a particular (more or less) constant perceived size.

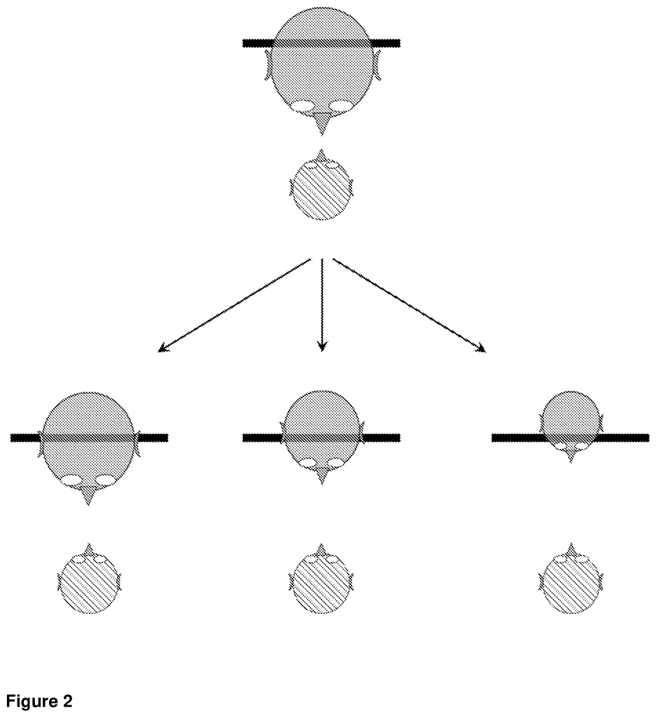

The action of the method of the invention is illustrated in FIG. 2, where the right displaying situation (IV) of FIG. 1 forms the starting point for the method of the invention (upper part of FIG. 2). The arrows represent different embodiments of the method of the invention, leading to three possible displaying situations. From left to right, these three displaying situations illustrate incremental changes in the displayed depth and the apparent displayed size, viz. an increasing displayed depth and a decreasing apparent displayed size.

Of course the number of possible displayed depths and apparent displayed sizes is virtually endless; which ones are actually applied depends on the settings of the autostereoscopic display device and the preferences of a user thereof, in particular of a second person (2). A particular setting of displayed depths and apparent displayed sizes entails that the scaled size and the scaled depth are in agreement with those which a second person (2) would experience in the real world when he would be looking at the first person (1) in the real world. In such setting, the screen of the autostereoscopic display device may be considered as a virtual window to another world.

Thus, a general advantage of the present invention is that it allows for adjusting both the size and depth of a displayed stereoscopic image to values that together best meet a viewer's viewing demands and/or viewing preferences.

For example, a viewer can adjust the depth at which another person is observed, to arrive at a depth he finds convenient (he may for example not want to perceive a displayed person too close in front of him, but neither too far—the exact desired depth is a personal matter). Moreover, at the same time, he can adjust the size of such person or object, to arrive at a size he finds optimal (for example because he wants that another part of the screen remains available for displaying other content, or because he wants that the perceived size has a certain relation with the perceived depth that he has set—a preference that may differ from one viewer to another). Thus, the method of the invention allows a viewer to personalize certain viewing characteristics of a displayed stereoscopic image (viz. the perceived depth and the perceived size), so that the viewer has a more pleasant viewing experience.

The method in particular allows that a viewer perceives a stereoscopic image of another person at a particular, preferred, size, given a particular, perceived, depth. More in particular, the scaled size and the scaled depth are in agreement with those which a viewer would experience when looking at the person as if this person was also present in the real world.

A particular advantage is that the present invention can compensate for movements of a recorded person that is recorded by a stereo camera and viewed by a viewer. By this is meant that the person's movements towards and away from the stereo camera do not fully translate to the displayed stereoscopic image, but are cancelled or at least attenuated. This provides the viewer with a more steady view of a person in a video, when displayed on an autostereoscopic display device.

The method of the invention is in its most basic form concerned with unidirectional communication, viz. from the first person to the second person, such as may occur in lectures, online education, webinars, tutorials and the like. The method may however be complemented by communication in the opposite direction, i.e. from the second person to the first person. As a result, the method is concerned with bidirectional communication.

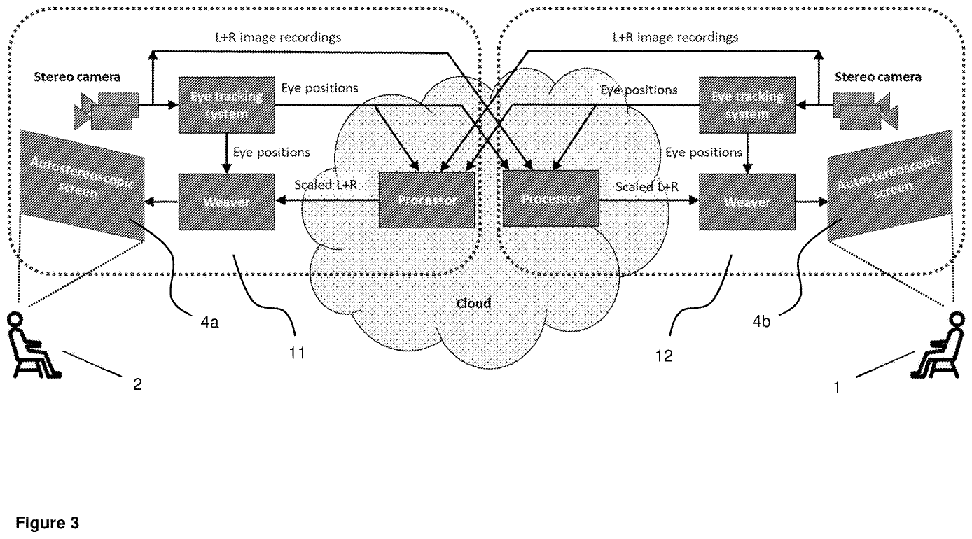

A method of the invention may therefore advantageously be applied in videoconferencing, allowing the first person and the second person, the two being remote from one another, to communicate with each other in sound and (three-dimensionally perceived) vision. In such setting, the first person and the second person both act as participants in an (online) meeting and have an autostereoscopic display device that is equipped to carry out the method of the invention. The autostereoscopic display device of the first person then comprises the stereo camera that operates, according to the method of the invention, with the autostereoscopic display device of the second person. This applies, mutatis mutandis, also to the autostereoscopic display device of the first person. FIG. 3 schematically displays such a videoconferencing setting, which will be further elaborated below.

Embodiments described above for the unidirectional communication from the first person to the second person form corresponding embodiments for the communication in the opposite direction, i.e. from the second person to the first person.

Accordingly, a method of the invention may further comprise driving a screen of a second autostereoscopic display device to display a stereoscopic image of the second person to the first person, wherein the first person is a viewer residing in a field of view of the screen of the second autostereoscopic display device, the method comprising
providing a stereoscopic recording of the second person by means of a stereo camera;
displaying to the first person the stereoscopic recording of the second person as a stereoscopic image composed of a left eye image and a right eye image, wherein the first person perceives the second person
   with an apparent displayed size, which is the angular size of the second person when the second person is viewed on the screen by the first person; and
   at a displayed depth, which is the depth at which the first person perceives the second person;
      wherein the method comprises
adjusting the apparent displayed size to a desired apparent displayed size by scaling the stereoscopic image of the second person;
adjusting the displayed depth to a desired displayed depth by changing a disparity between the left eye image and the right eye image of the second person.

In such method, a preferred way to arrive at a certain desired apparent displayed size of the second person comprises deriving it from the desired displayed depth, by performing the steps of
h) providing the desired displayed depth at which the first person perceives the second person;
i) determining a viewing distance of the first person's eyes to the screen;
j) determining a recording distance of the second person to the stereo camera;
k) determining an apparent real world size of the second person, which is the angular size when the second person is viewed in the real world from the recording distance obtained under c);
l) calculating the desired apparent displayed size of the second person, which is the angular size when the second person is viewed in the real world from the desired displayed depth provided under a), by using
   the desired displayed depth provided under a);
   the viewing distance obtained under b);
   the apparent real world size obtained under d);
m) scaling the stereoscopic image to adjust the apparent displayed size to the desired apparent displayed size;
n) fitting the stereoscopic image that is scaled in step m) to the screen by cropping the image when the image is larger than the screen.

In such method, an additional scaling may occur according to a second percentage that is in the range of 50-150%, in particular in the range of 80-120%, more in particular in the range of 95-105% and even more in particular in the range of 99-101%. In this way, the first person is allowed to adjust the desired apparent displayed size to an even more desired apparent displayed size.

In such method, the stereoscopic recording of the second person may be represented by a stereoscopic recording of the head of the second person, so that the stereoscopic image of the second person is represented by a stereoscopic image of the head of the second person.

An image of the second person may comprise the real background behind the second person at the moment the stereoscopic recording of the second person is made, i.e. the original background that is part of the reality wherein the second person is present. Usually, however, the second person is segmented from the original background, so that the displayed image of the second person does not comprise the original background. Such segmentation of parts of an image can be performed according to methods known in the art.

When a background is lacking due to such segmentation of the second person (or e.g. the head of the first person), then another background is usually introduced behind the stereoscopic image of the second person. Such background can be scaled to a second desired extent, which usually occurs independently of the scaling of the stereoscopic (foreground) image of the second person. Without segmentation of the second person from the background, the scaling of the stereoscopic image of the second person will result in scaling of the background to the same extent. This may give a weird appearance of the background to the viewer of the image.

Accordingly, such method may further comprise
providing a recording of a background, obtained by a camera or a stereo camera;
simultaneously displaying on the screen to the first person
   the recording of the background as a background image; and
   the stereoscopic recording of the second person as a stereoscopic foreground image;
optionally scaling the background image to a second desired extent;
fitting the background image to the screen by cropping the image when the image is larger than the screen.

During videoconferencing, the method of the invention is usually performed a plurality of times in a sequence. In this way, a new position of the first and/or second person relative to an autostereoscopic display and a stereo camera, respectively, can be accounted for. For example, the method is repeated at least 10 times, at least 100 times, at least 1,000 times, at least 10,000 times, at least 100,000 times or at least 1,000,000 times. Any repetition of the method of the invention, for example with one of the above numbers, may reflect a particular videoconferencing session of the viewer.

For a realistic viewing experience, the method is usually performed at a frequency that is at least 10 times per second. Preferably, the frequency is at least 20 times per second, more preferably at least 30 times per second, and even more preferably at least 50 times per second. For example, it is in the range of 50 -250 times per second, in the range of 55-150 times per second or in the range of 60-120 times per second. It may in particular be 60 Hz, 120 Hz, 144 Hz or 240 Hz. Preferably, it is at the same frequency as a refresh rate of the screen itself.

When the method of the invention is performed as a videoconferencing method, then it may be advantageous to allow for each person that the other person is perceived at (substantially) the same depth relative to the screen, each time the method is performed.

For example, both persons may prefer to constantly perceive the other person just behind the screen (or with the eyes in the plane of the screen) wherein the other person has a more or less constant coverage of screen area, even when he has a varying position relative to the stereo camera so that there is a varying recording distance. This gives both persons a more steady image to look at, wherein the displayed image does not constantly jump between different sizes when each of both persons moves away from or towards his respective stereo camera.

Just as with a single viewer as described above, also in a videoconferencing embodiment may the perceived depth follow a varying recording distance to a minor extent, as this will already increase viewing comfort as experienced by both viewers. For example, the perceived depth exhibits a variation between a lower value and a higher value, wherein the higher value is up to 2 times the lower value. It is for example up to 1.6 times the lower value, up to 1.5 times the lower value, up to 1.4 times the lower value, up to 1.3 times the lower value, up to 1.2 times the lower value, up to 1.1 times the lower value, up to 1.07 times the lower value, up to 1.05 times the lower value, up to 1.03 times the lower value, up to 1.02 times the lower value, or up to 1.01 times the lower value.

Especially when the recording distance is reduced by a large percentage (e.g. when a recorded person comes rather close to the stereo camera that is recording him), screen coverage at the side of a viewing person would normally increase enormously. Such increase exceeds the enlargements that are inherently perceived by a viewer when observing objects at close range, because the recording distance becomes much smaller than the displayed depth.

A method of the present invention is however able to compensate for such effects, allowing the display of both persons at a (more or less) constant depth and at a (more or less) constant perceived size during a videoconferencing session.

In a method of the invention, the first and/or the second autostereoscopic display device may be a device that is largely stationary in the real world during its use, such as a desktop device (e.g. a desktop computer monitor or a laptop) or a wall-mounted device (e.g. a television or a cinema display system). It may however also be a portable device such as a mobile phone, a tablet or a game console, allowing a viewer to (freely) move within the real world. It may also be a display in a vehicle, watercraft or aircraft, such as a car, a train, a boat or an airplane.

In a method of the invention, the stereoscopic recording may be stored on a data carrier such as a memory stick or a hard disk. The autostereoscopic display device then obtains the stereoscopic recording from such storage.

Alternatively, the autostereoscopic display device obtains the stereoscopic recording ‘live’ without reading it from a memory. Accordingly, in a method of the invention, the stereoscopic recording may be contained in a memory part associated with the autostereoscopic display device or it may be a live video stream.

FIG. 3 schematically displays a videoconferencing setting wherein a method according to the invention is applied. Two different environments are displayed; a left environment wherein a second person (2) sits in front of a first autostereoscopic display device (11) and right environment wherein a first person (1) sits in front of a second autostereoscopic display device (12). Different components of both autostereoscopic display devices (11, 12) are schematically drawn, i.e. an autostereoscopic screen (4a, 4b), a stereo camera, an eye tracking system, a weaver and a processor.

The stereo camera in the second autostereoscopic display device (12) provides left eye image and right eye image recordings of the first person (1). These images are sent to the processor of the first autostereoscopic display device (11) where they are scaled in the processor, taking account of eye positions of the second person (2) (viewing distance) and eye positions of the first person (1) (recording distance). This yields scaled left and right eye images that are sent to the weaver. With eye position input of the second person (2), provided by the eye tracking system of the first autostereoscopic display device (11), the weaver controls the screen of the first autostereoscopic display device (11) so as to display a stereoscopic image of the first person (1) to the second person (2) on the autostereoscopic screen (4a).

The same process occurs, mutatis mutandis, when the second person (2) is recorded by the first autostereoscopic display device (11) and displayed at the second autostereoscopic display device (12) to the first person (1) on the autostereoscopic screen (4b).

The processor activity of the two processors is in this example not performed in the respective autostereoscopic display device (12), but ‘in the cloud’.

1-16. (canceled)

17. A method for displaying a stereoscopic image on an autostereoscopic display device, the method comprising:
receiving a stereoscopic recording of a first person captured by a stereo camera;
displaying the stereoscopic recording as a stereoscopic image on a screen of the autostereoscopic display device to a second person located in a field of view of the screen, the stereoscopic image comprising a left eye image of the first person and a right eye image of the first person;
scaling the stereoscopic image to adjust an apparent displayed size of the first person, the apparent displayed size being an angular size of the first person on the screen as viewed by the second person; and
modifying a disparity between the left eye image and the right eye image to adjust a perceived depth of the first person, the perceived depth being a depth at which the second person perceives the first person relative to the screen.

18. The method of claim 17, wherein scaling the stereoscopic image comprises:
providing a desired perceived depth of the first person at which the second person perceives the first person;
determining a viewing distance from the screen to eyes of the second person;
determining a recording distance of the first person to the stereo camera;
determining an apparent real world size of the first person, the apparent real world size being an angular size of the first person when viewed in the real world from the recording distance;
calculating a desired apparent displayed size of the first person, the desired apparent displayed size being the angular size of the first person when viewed in the real world from the desired perceived depth, the calculating being based on the desired perceived depth, the viewing distance, and the apparent real world size;
scaling the stereoscopic image to adjust the apparent displayed size of the first person to the desired apparent displayed size; and
fitting the stereoscopic image to the screen by cropping the stereoscopic image when the stereoscopic image is larger than the screen.

19. The method of claim 17, wherein scaling the stereoscopic image comprises:
scaling the stereoscopic image by scaling percentage, the scaling percentage being in a range selected from 50% to 150%, 80% to 120%, 95% to 105%, or 99% to 101 %.

20. The method of claim 17, wherein:
the stereoscopic recording of the first person comprises a stereoscopic recording of a head of the first person; and
the stereoscopic image of the first person comprises a stereoscopic image of the head of the first person.

21. The method of claim 17, further comprising:
providing a background recording captured by one of a camera or a stereo camera;
simultaneously displaying on the screen to the second person:
the background recording as a background image; and
the stereoscopic recording of the first person as a stereoscopic foreground image; and
fitting the background image to the screen by cropping the background image when the background image is larger than the screen.

22. The method of claim 21, further comprising:
selective scaling the background image, prior to fitting the background image to the screen.

23. The method of claim 17, wherein the method is performed multiple times.

24. The method of claim 23, wherein:
the first person is perceived by the second person at a depth relative to the autostereoscopic display device, the depth being substantially constant each time the method is performed.

25. The method of claim 23, wherein:
the first person is perceived by the second person at a depth relative to the autostereoscopic display device, the depth being variable between a lower value and a higher value, the higher value being selected from:
up to 1.5 times the lower value;
up to 1.2 times the lower value;
up to 1.1 times the lower value; or
up to 1.05 times the lower value.

26. The method of claim 17, wherein the method is used in videoconferencing.

27. The method of claim 17, further comprising:
displaying a stereoscopic image of the second person to the first person on a screen of a second autostereoscopic display device, the first person being located in a field of view of the screen of the second autostereoscopic display device;
providing a stereoscopic recording of the second person captured by a second stereo camera;
displaying the stereoscopic recording of the second person on a screen of the second autostereoscopic display device as a second stereoscopic image to the first person located in a field of view of the screen, the second stereoscopic image comprising a left eye image of the second person and a right eye image of the second person;
scaling the second stereoscopic image to adjust an apparent displayed size of the second person, the apparent displayed size being an angular size of the second person on the screen of the second autostereoscopic display device as viewed by the first person; and
modifying a disparity between the left eye image and the right eye image of the second person to adjust a perceived depth of the second person, the perceived depth being a depth at which the first person perceives the second person relative to the screen of the second autostereoscopic display device.

28. The method of claim 27, wherein scaling the second stereoscopic image comprises:
providing a desired perceived depth of the second person at which the first person perceives the second person;
determining a viewing distance from the screen of the second autostereoscopic display device to eyes of the first person;
determining a recording distance between the second person and the second stereo camera;
determining an apparent real world size of the second person, the apparent real world size being the angular size of the second person when viewed in the real world from the recording distance;
calculating a desired apparent displayed size of the second person, the desired apparent displayed size being the angular size of the second person when viewed in the real world from the desired perceived depth, the calculating being based on the desired perceived depth, the viewing distance, and the apparent real world size;
scaling the second stereoscopic image to adjust the apparent displayed size of the second person to the desired apparent displayed size; and
fitting the scaled second stereoscopic image to the screen of the second autostereoscopic display device by cropping the second stereoscopic image when the second stereoscopic image is larger than the screen.

29. The method of claim 27, wherein scaling the second stereoscopic image comprises:
scaling the second stereoscopic image by a scaling percentage, the scaling percentage being in a range selected from 50% to 150%, 80% to 120%, 95% to 105%, or 99% to 101%.

30. The method of claim 27, wherein:
the stereoscopic recording of the second person comprises a stereoscopic recording of a head of the second person; and
the second stereoscopic image comprises a stereoscopic image of the head of the second person.

31. The method of claim 27, further comprising:
providing a second background recording captured by one of a camera and a stereo camera,
simultaneously displaying on the screen of the second autostereoscopic display device to the first person:
the second background recording as a second background image, and
the stereoscopic recording of the second person as a stereoscopic foreground image; and
fitting the second background image to the screen of the second autostereoscopic display device by cropping the second background image when the second background image is larger than the screen.

32. The method of claim 31, further comprising:
selective scaling the background image, prior to fitting the background image to the screen.

33. The method of claim 27, wherein the method is performed multiple times.

34. The method of claim 33, wherein:
the second person is perceived by the first person at a depth relative to the second autostereoscopic display device that is substantially constant each time the method is performed.

35. The method of claim 33, wherein:
the second person is perceived by the first person at a depth relative to the second autostereoscopic display device that is variable between a lower value and a higher value, the higher value being selected from:
up to 1.5 times the lower value;
up to 1.2 times the lower value;
up to 1.1 times the lower value; or
up to 1.05 times the lower value.

36. The method of claim 17, wherein at least one of the autostereoscopic display device and the second autostereoscopic display device is a television, a desktop computer monitor, a laptop, a cinema display system, a mobile phone, a display in a car, a tablet, or a game console.
